(19) United States
(12) Patent Application Publication
(10) Pub. No.: US 2022/0143807 A1
(43) Pub. Date: May 12, 2022

(54) RETRACTABLE PICKUP DEVICE

(71) Applicant: Shenzhen Lianhong Plastic Mould Products Co., Ltd., Shenzhen (CN)

(72) Inventor: Guicheng Li, Shenzhen (CN)

(21) Appl. No.: 17/584,412

(22) Filed: Jan. 26, 2022

(51) Int. Cl. B25J 1/04

(52) U.S. Cl. CPC B25J 1/04; B25J 18/025

(57) ABSTRACT

The present disclosure provides a retractable pickup device. A chuck subassembly of the retractable pickup device includes: a control handle subassembly, a driving subassembly that is in driving connection with the control handle subassembly, and a chuck subassembly that is in driving connection with the driving subassembly. The control handle subassembly drives the chuck subassembly to be closed and opened through the driving subassembly, so as to achieve picking and placement of an object. The present disclosure has the beneficial effects that in the actual operation, the control handle subassembly is operated to drive the chuck subassembly to be closed and opened through the driving subassembly, so as to achieve picking and placement of the object. Therefore, the retractable pickup device after the improvement is simpler in both structure and operation, which further improves the operation experience of a user.

### TECHNICAL FIELD

The present disclosure belongs to the technical field of pickup tools, in particular to a retractable pickup device.

### BACKGROUND

In life, various small objects often fall into places such as a gap. Since the gap is small and is generally dark, it is not easy to pick up objects. At present, there are basically no special tools to pick up objects in such situations, so it is inconvenient in such cases. In addition, for example, when it is hard for a person for pick-and-place to reach the object in accordance with the length of the arm, or this type of clamping device is often used for cleaning. Therefore, people have developed a pickup device. However, common retractable pickup devices currently on the market have complex structure and operation. Designing a pickup device with a relatively simple structure and operation has become an urgent problem for designers to solve.

### SUMMARY

The present disclosure mainly aims to provide a retractable pickup device. A clamp device that is complex in both structure and operation on the market is improved. By means of disposing a control handle subassembly, a driving subassembly that is in driving connection with the control handle subassembly, and a chuck subassembly that is in driving connection with the driving subassembly, in actual operations, the control handle subassembly is operated to drive the chuck subassembly to be closed and opened through the driving subassembly, so as to achieve picking and placement of an object. Therefore, the retractable pickup device after the improvement is simple in both structure and operation, which further improves the operation experience of a user.

In order to solve the above technical problems, the present disclosure provides the following technical solutions:

A retractable pickup device includes a control handle subassembly, a driving subassembly that is in driving connection with the control handle subassembly, and a chuck subassembly that is in driving connection with the driving subassembly. The control handle subassembly drives the chuck subassembly to be closed and opened through the driving subassembly, so as to achieve picking and placement of an object.

As one preferable solution of the present disclosure, the chuck subassembly includes a clamping jaw body, and clamping jaw heads which are symmetrically arranged on two sides of the clamping jaw body and are in pivot-hinge to the clamping jaw body; the driving subassembly is arranged in the clamping jaw body; a linkage part is arranged at a tail of each clamping jaw head; the linkage part extends into the driving subassembly; the driving subassembly drives the clamping jaw heads to be closed through the linkage parts after sliding to a position away from the clamping jaw heads; and the driving subassembly drives the clamping jaw heads to be opened through the linkage parts after sliding towards the clamping jaw heads.

As one preferable solution of the present disclosure, an antiskid pad is arranged on the inner side of each clamping jaw head, and an antiskid protrusion is arranged on the antiskid pad; and the antiskid pads are used for increasing a friction force when the clamping jaw heads clamp the object.

As one preferable solution of the present disclosure, the driving subassembly includes a driving member body, a driving connecting rod mounted on the driving member body, and an elastic reset member sleeved on the driving connecting rod; the linkage parts extend into the driving member body; one end of the elastic reset member resists against the driving member body, and the other end of the elastic reset member resists against the clamping jaw body; after the driving connecting rod is driven to drive the driving member body to slide towards the position away from the clamping jaw heads, the elastic reset member is compressed and generates elastic restoring force; and after the driving force disappears, the elastic restoring force of the elastic reset member pushes the driving member body and the diving connecting rod towards the clamping jaw heads.

As one preferable solution of the present disclosure, a driving member sliding chute is provided at a position, corresponding to the driving member body, on the inner side of the clamping jaw body, and the driving member sliding chute is used for allowing the driving member body to slide.

As one preferable solution of the present disclosure, the control handle subassembly includes a handle, a trigger mounted on the handle, and a clockwork spring box which is in driving connection with the trigger; a pull rope is arranged between the clockwork spring box and the driving connecting rod; the trigger is pulled to drive the clockwork spring box to withdraw the pull rope into the clockwork spring box, so that the pull rope pulls the driving connecting rod to move towards a direction away from the clamping jaw heads; the trigger is released, so that the clockwork spring box drives the trigger to be reset, and the elastic reset member drives the driving connecting rod to be reset; and the driving connecting rod pulls out the pull rope from the clockwork spring box.

As one preferable solution of the present disclosure, an axis of the clockwork spring box is provided with an engagement gear; a position of the trigger corresponding to the engagement gear is provided with an engagement part; the engagement part can be engaged with the engagement gear; the trigger is pulled, so that the engagement part is engaged with and drives the engagement gear to drive the clockwork spring box to be rolled back; and the trigger is released, so that the engagement gear of the clockwork spring box is engaged with and drives the engagement part of the trigger to reset the trigger.

As one preferable solution of the present disclosure, the retractable pickup device further includes: a telescopic rod subassembly; one end of the telescopic rod subassembly is provided with the control handle subassembly, and the other end of the telescopic rod subassembly is provided with the chuck subassembly; the pull rope passes through the telescopic rod subassembly; and the telescopic rod subassembly is used for adjusting a distance between the control handle subassembly and the chuck subassembly.

As one preferable solution of the present disclosure, the telescopic rod subassembly includes: an outer connecting rod, an inner connecting rod plugged to the outer connecting rod to do extend-retract motion, and a locking member capable of restraining the inner connecting rod from doing the extend-retract motion relative to the outer connecting rod; the locking member includes an elastic self-locking member mounted on the outer connecting rod and a nut sleeved on the inner connecting member; the inner connecting rod passes through the elastic self-locking member and extends into the outer connecting rod; the nut is tightened on the elastic self-locking member to enable the elastic self-locking member to resist against the inner connecting rod, so that the inner connecting rod is locked relative to the outer connecting rod; the nut is loosened from the elastic self-locking member to enable the elastic self-locking member to be released from the inner connecting member, so that the inner connecting rod is unlocked relative to the outer connecting rod.

As one preferable solution of the present disclosure, the elastic self-locking member is provided with a limiting protrusion; a position of the inner connecting rod corresponding to the limiting protrusion is provided with a limiting slot; and the limiting protrusion is clamped in the limiting slot and can slide in the limiting slot, so as to restrain the inner connecting rod from rotating relative to the outer connecting rod.

The present disclosure has the beneficial effects.

1. A clamp device that is complex in both structure and operation on the market is improved. By means of disposing a control handle subassembly, a driving subassembly that is in driving connection with the control handle subassembly, and a chuck subassembly that is in driving connection with the driving subassembly, in actual operations, the control handle subassembly is operated to drive the chuck subassembly to be closed and opened through the driving subassembly, so as to achieve picking and placement of an object. Therefore, the retractable pickup device after the improvement is simple in both structure and operation, which further improves the operation experience of a user.

2. The antiskid pad is mounted on the inner side of each clamping jaw head, and the antiskid protrusion is arranged on the antiskid pad. When the chuck subassembly clamps an object, the antiskid pads can further clamp the object so that it is difficult for the object to fall off, which further improves the stability of clamping the object by the clamping device.

### BRIEF DESCRIPTION OF THE DRAWINGS

In order to describe the technical solutions in the embodiments of the present disclosure more clearly, accompanying drawings required to be used in the descriptions of the embodiments will be briefly introduced below. Obviously, the drawings in the illustration below are merely some embodiments of the present disclosure. Those ordinarily skilled in the art also can acquire other drawings according to these drawings without doing creative work, and the drawings all fall within the protection scope of the present disclosure.

FIG. 1 is a schematic structural diagram of a retractable pickup device according to an embodiment of the present disclosure;

FIG. 2 is a sectional view of the retractable pickup device shown in FIG. 1;

FIG. 3 is an exploded view of the retractable pickup device shown in FIG. 1;

FIG. 4 is a schematic structural diagram of a chuck subassembly of the retractable pickup device shown in FIG. 3;

FIG. 5 is an exploded view of the chuck subassembly of the retractable pickup device shown in FIG. 3;

FIG. 6 is a schematic structural diagram of a clamping jaw head of the retractable pickup device shown in FIG. 5;

FIG. 7 is a schematic structural diagram of an antiskid pad of the retractable pickup device shown in FIG. 5;

FIG. 8 is a schematic structural diagram of a clamping jaw body of the retractable pickup device shown in FIG. 5;

FIG. 9 is a schematic structural diagram of a driving subassembly and a clamping jaw head of the retractable pickup device shown in FIG. 3;

FIG. 10 is an exploded view of a driving subassembly and a clamping jaw head of the retractable pickup device shown in FIG. 9;

FIG. 11 is a schematic structural diagram of a driving member body of the retractable pickup device shown in FIG. 10;

FIG. 12 is a schematic structural diagram of a driving connecting rod of the retractable pickup device shown in FIG. 10;

FIG. 13 is a schematic structural diagram of an elastic reset member of the retractable pickup device shown in FIG. 10;

FIG. 14 is a schematic structural diagram of a control handle subassembly of the retractable pickup device shown in FIG. 3;

FIG. 15 is a partially sectional view of a control handle subassembly of the retractable pickup device shown in FIG. 14;

FIG. 16 is a schematic structural diagram of a telescopic rod subassembly of the retractable pickup device shown in FIG. 3;

FIG. 17 is an exploded view of the telescopic rod subassembly of the retractable pickup device shown in FIG. 16;

FIG. 18 is a schematic structural diagram of an inner connecting rod of the retractable pickup device shown in FIG. 17;

FIG. 19 is a schematic structural diagram of an elastic self-locking member of the retractable pickup device shown in FIG. 17; and

FIG. 20 is a schematic structural diagram of a nut of the retractable pickup device shown in FIG. 17.

### DETAILED DESCRIPTION OF THE EMBODIMENTS

The technical solutions in the embodiments of the present disclosure will be described clearly and completely below. Obviously, the embodiments described herein are only part of the embodiments of the present disclosure, not all the embodiments. Based on the embodiments in the present disclosure, all other embodiments obtained by those of ordinary skill in the art without creative work shall fall within the protection scope of the present disclosure.

Therefore, the following detailed description for the embodiments of the present disclosure provided in the accompanying drawings is not intended to limit the scope of the claimed present disclosure, but merely represents selected embodiments of the present disclosure. It should be noted that, in the case of no conflict, various features in the embodiments of the present disclosure can be combined with each other, and the combined embodiments still fall within the protection scope of the present disclosure.

It should be noted that similar reference signs and letters indicate similar items in the following drawings. Therefore, once a certain item is defined in one drawing, it is unnecessary to be further defined and explained in the subsequent drawings.

In the description of the present disclosure, it should be noted that orientations or positional relationships indicated by the terms “center”, “upper”, “lower”, “left”, “right”, “vertical”, “horizontal”, “inner” and “outer” are based on the orientations or positional relationships shown in the accompanying drawings, or the orientations or positional relationships where a product of the present disclosure is usually placed during use, which are only for the convenience of describing the present disclosure and simplifying the description, not intended to indicate or imply that the referred device or element must have a particular orientation and be constructed and operated in a particular orientation. Therefore, they should not be construed as a limitation to the present disclosure. In addition, the terms “first”, “second”, “third”, etc. are only for the purpose of distinguishing descriptions, and may not be understood as indicating or implying the relative importance.

In addition, the terms “horizontal”, “vertical”, and the like do not mean that the component is required to be absolutely horizontal or overhanging, but may be slightly inclined. For example, “horizontal” only means that its direction is more horizontal than “vertical”, and it does not mean that the structure must be completely horizontal, but can be slightly inclined.

In the description of the present disclosure, it should be also noted that unless otherwise explicitly defined and defined, the terms “arranged”, “mounted”, “coupled”, and “connected” shall be understood broadly, and may be, for example, fixedly connected, or removably connected, or integrally connected, or mechanically connected, or electrically connected, or directly connected, or indirectly connected through an intermediate medium, or interconnection between two elements. Those of ordinary skill in the art can understand the specific meanings of the above terms in the present disclosure according to specific situations.

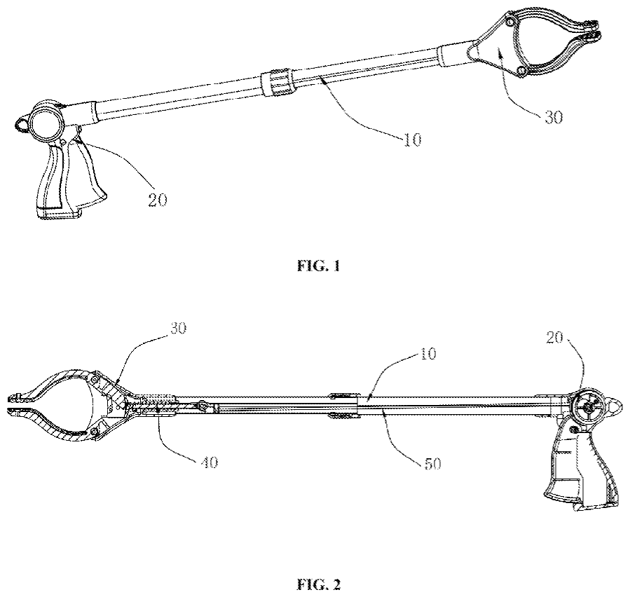

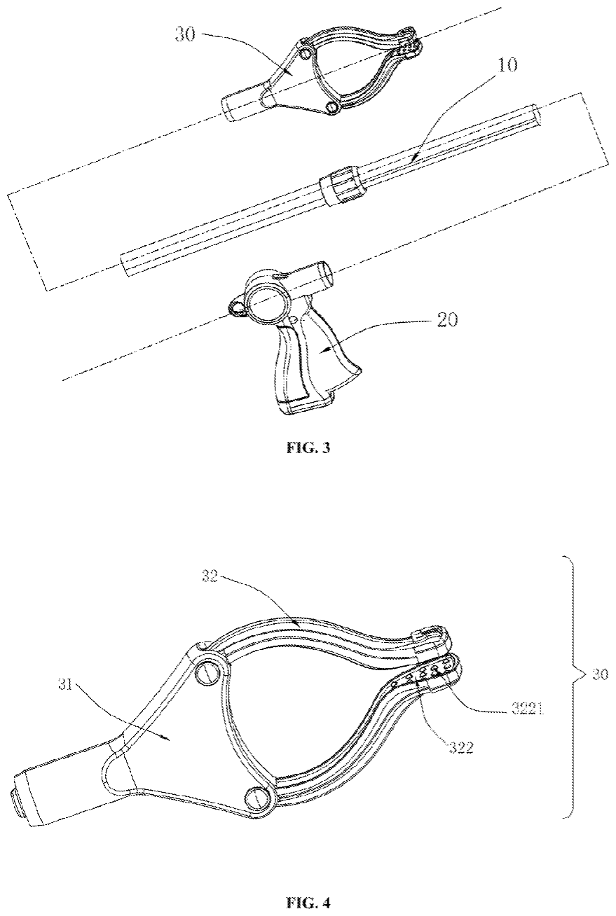

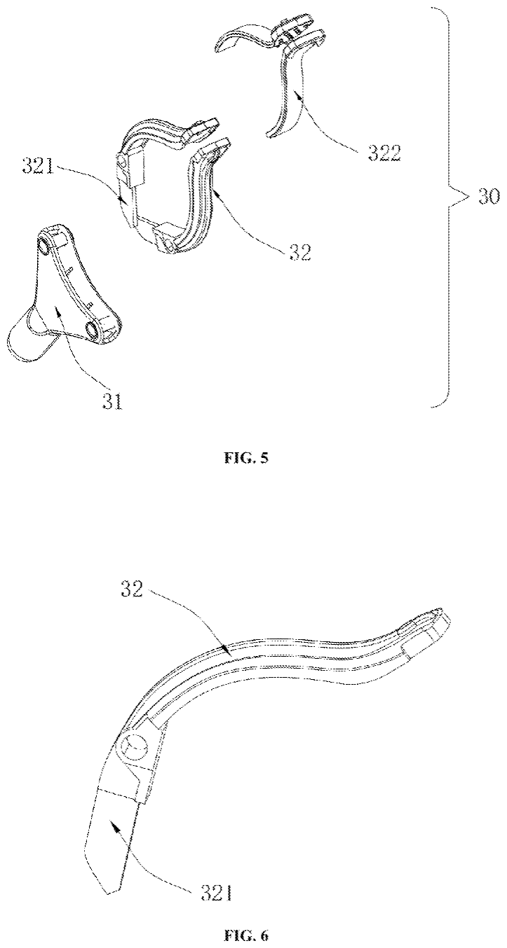

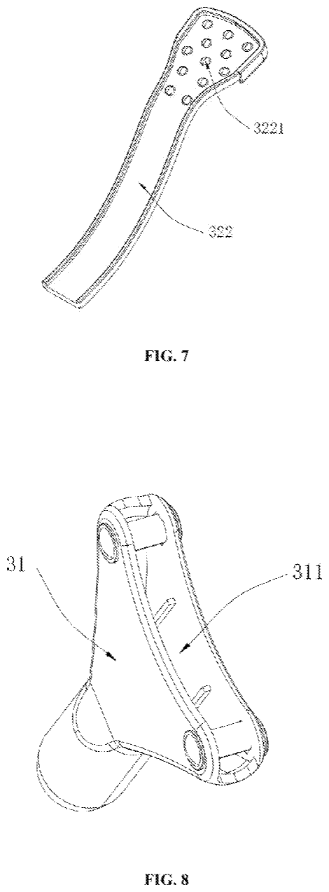

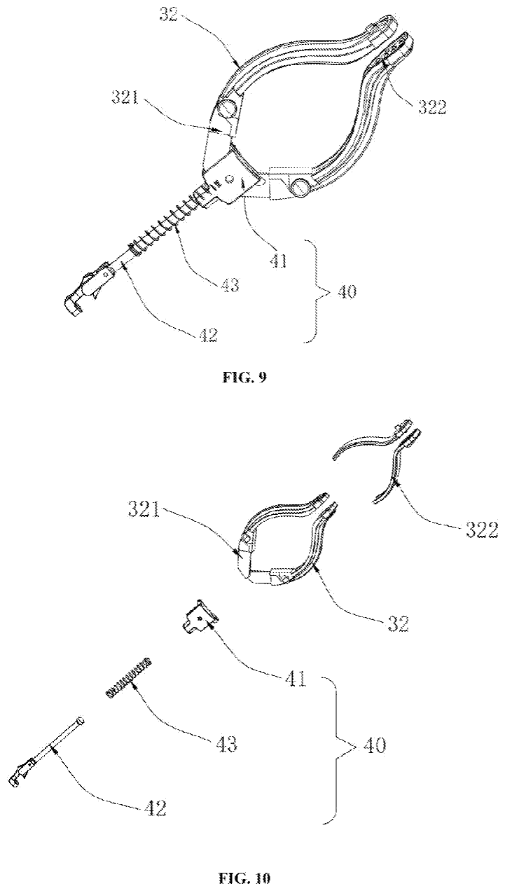

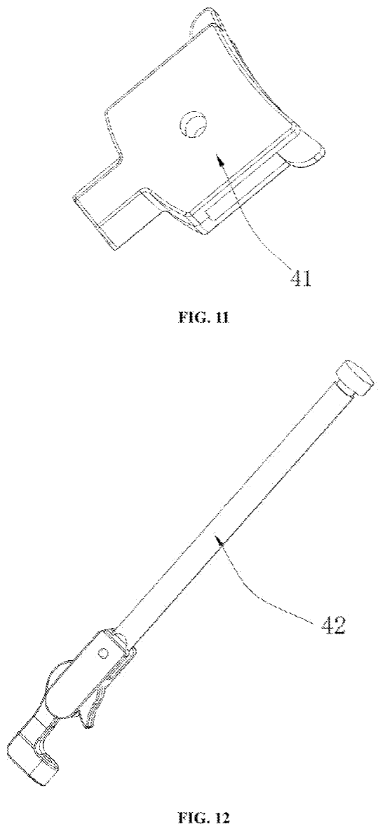

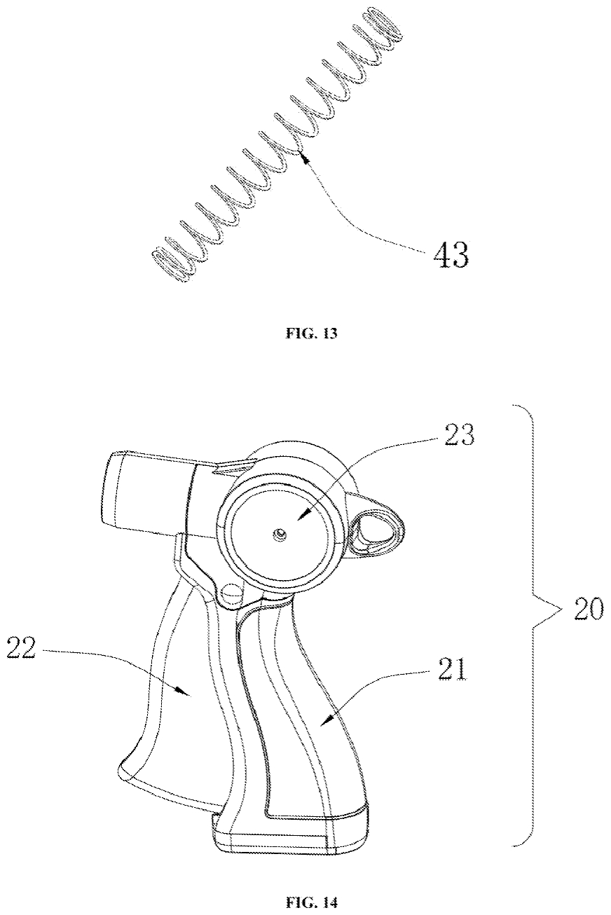

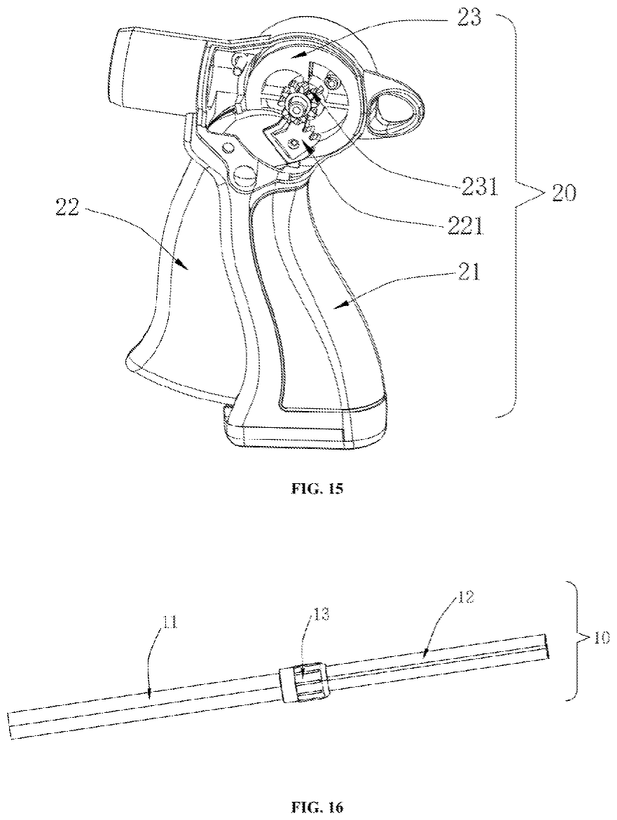

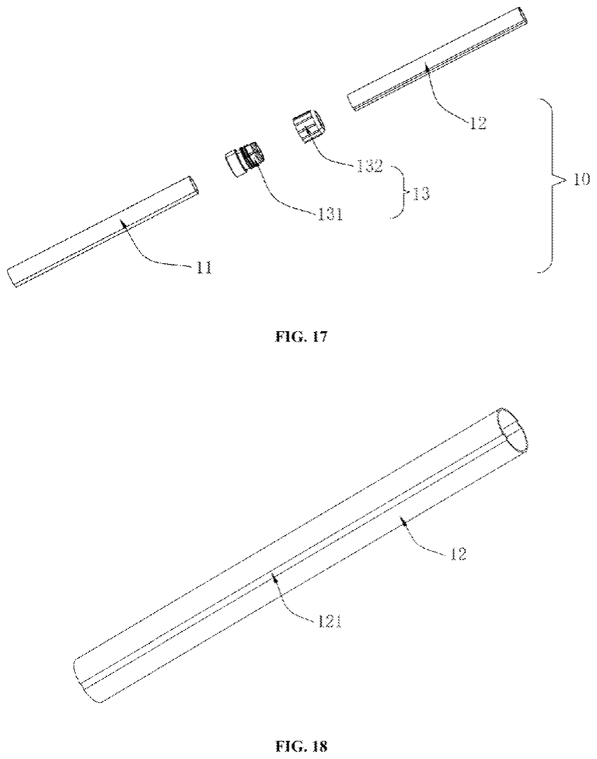

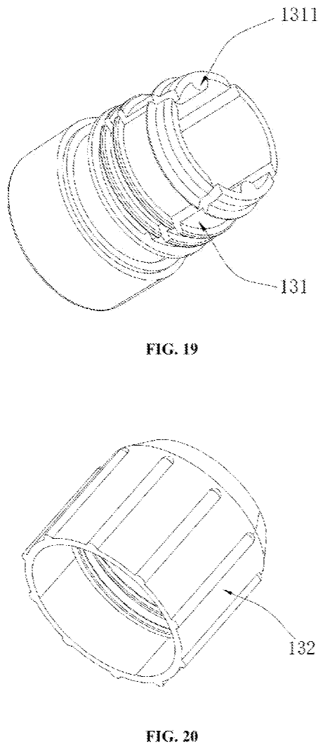

As shown in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, and FIG. 20, an embodiment of the present disclosure provide a retractable pickup device, including: a telescopic rod subassembly 10, a control handle subassembly 20 mounted at one end of the telescopic rod subassembly 10, a chuck subassembly 30 mounted at the other end of the telescopic rod subassembly 10, and a driving subassembly 40 mounted in the chuck subassembly 30. The driving subassembly 40 is in driving connection with the chuck subassembly 30. The control handle subassembly 20 is in driving connection with the driving subassembly 40, so that the control handle subassembly 20 drives the chuck subassembly 30 to be closed and opened through the driving subassembly 40 to achieve picking and placement of an object.

A clamp device that is complex in both structure and operation on the market is improved. By means of disposing the control handle subassembly 20, the driving subassembly 40 that is in driving connection with the control handle subassembly 20, and the chuck subassembly 30 that is in driving connection with the driving subassembly 40, in actual operations, the control handle subassembly 20 is operated to drive the chuck subassembly 30 to be closed and opened through the driving subassembly 40, so as to achieve picking and placement of the object. Therefore, the retractable pickup device after the improvement is simple in both structure and operation, which further improves the operation experience of a user.

Specifically, the chuck subassembly 30 includes a clamping jaw body 31, and clamping jaw heads 32 which are symmetrically arranged on two sides of the clamping jaw body 31 and are in pivot-hinge to the clamping jaw body 31. A linkage part 321 is arranged at a tail of each clamping jaw head 32. The linkage part 321 extends into the driving subassembly 40.

During an operation, after the driving subassembly 40 slides towards a position away from the clamping jaw heads 32, the driving subassembly 40 drives the clamping jaw heads 32 to be closed through the linkage parts 321. After the driving subassembly 40 slides towards the clamping jaw heads 32, the driving subassembly 40 drives the clamping jaw heads 32 to be opened through the linkage parts 321.

In order to make the chuck subassembly 30 stabler when it clamps an object, an antiskid pad 322 is arranged on the inner side of each clamping jaw head 32, and an antiskid protrusion 3221 is arranged on the antiskid pad 322; and the antiskid pads 322 are used for increasing a friction force when the clamping jaw heads 32 clamp the object. Therefore, when the chuck subassembly 30 clamps the object, the antiskid pads 322 can further clamp the object so that it is difficult for the object to fall off, which further improves the stability of clamping the object by the clamping device.

In the present disclosure, the driving subassembly 40 includes: the driving subassembly includes a driving member body 41, a driving connecting rod 42 mounted on the driving member body 41, and an elastic reset member 43 sleeved on the driving connecting rod 42. The linkage parts 321 extend into the driving member body 41. One end of the elastic reset member 43 resists against the driving member body 41, and the other end of the elastic reset member 43 resists against the clamping jaw body 31.

In the operation process, after the driving connecting rod 42 is driven to drive the driving member body 41 to slide towards the position away from the clamping jaw heads 32, the clamping jaw heads 32 are closed, and the elastic reset member 43 is compressed and generates elastic restoring force. After the driving force disappears, the elastic restoring force pushes the driving member body 41 and the diving connecting rod 42 towards the clamping jaw heads 32, so that the clamping jaw heads 32 are opened.

In order to cause the driving member body 41 to be able to slide in the clamping jaw body 31, a driving member sliding chute 311 is provided at a position, corresponding to the driving member body 41, on the inner side of the clamping jaw body 31, and the driving member sliding chute 311 is used for allowing the driving member body 41 to slide.

In the present disclosure, the control handle subassembly 20 includes a handle 21, a trigger 22 mounted on the handle 21, and a clockwork spring box 23 which is in driving connection with the trigger 22. A pull rope 50 is arranged between the clockwork spring box 23 and the driving connecting rod 42. When the trigger 22 is pulled, the clockwork spring box 23 is driven to withdraw the pull rope 50 into the clockwork spring box 23, so that the pull rope 50 pulls the driving connecting rod 42 to move towards a direction away from the clamping jaw heads 32. When the trigger 22 is released, the clockwork spring box 23 drives the trigger 22 to be reset, and the elastic reset member 43 drives the driving connecting rod 42 to be reset. The driving connecting rod 42 pulls out the pull rope 50 from the clockwork spring box 23.

In order to enable the clockwork spring box 23 and the trigger 22 to drive each other, an axis of the clockwork spring box 23 is provided with an engagement gear 231. A position of the trigger 22 corresponding to the engagement gear 231 is provided with an engagement part 221. The engagement part 221 can be engaged with the engagement gear 231.

In the operation process, when the trigger 22 is pulled, the engagement part 221 is engaged with and drives the engagement gear 231 to drive the clockwork spring box 23 to be rolled back. When the trigger 22 is released, the engagement gear 231 of the clockwork spring box 23 is engaged with and drives the engagement part 221 of the trigger 22 to reset the trigger 22.

In the present disclosure, since one end of the telescopic rod subassembly 10 is provided with the control handle subassembly 20, and the other end of the telescopic rod subassembly 10 is provided with the chuck subassembly 30, the pull rope 50 passes through the telescopic rod subassembly 10, and the telescopic rod subassembly 10 is used for adjusting a distance between the control handle subassembly 20 and the chuck subassembly 30, which is convenient for a user to pick up objects spaced apart from the user at different distances.

Specifically, the telescopic rod subassembly 10 includes: an outer connecting rod 11, an inner connecting rod 12 plugged to the outer connecting rod 11 to do extend-retract motion, and a locking member 13 capable of restraining the inner connecting rod 12 from doing the extend-retract motion relative to the outer connecting rod 11. The locking member 13 includes an elastic self-locking member 131 mounted on the outer connecting rod 11 and a nut 132 sleeved on the inner connecting rod 12. The inner connecting rod 12 passes through the elastic self-locking member 131 and extends into the outer connecting rod 11.

In the operation process, the inner connecting rod 12 does the extend-retract motion relative to the outer connecting rod 11 to adjust the length of the telescopic rod subassembly 10. The nut 132 is then tightened on the elastic self-locking member 131 to enable the elastic self-locking member 131 to resist against the inner connecting rod 12, so that the inner connecting rod 12 is locked relative to the outer connecting rod 11. When the length of the telescopic rod subassembly 10 is required to be adjusted again, the nut 132 is loosened from the elastic self-locking member 131 to enable the elastic self-locking member 131 to be released from the inner connecting rod 12, so that the inner connecting rod 12 is unlocked relative to the outer connecting rod 11. Therefore, the length of the telescopic rod subassembly 10 can be adjusted again.

In order to enable the inner connecting rod 12 not to rotate when the outer connecting rod 11 does the extend-retract motion, the elastic self-locking member 131 is provided with a limiting protrusion 1311. A position of the inner connecting rod 12 corresponding to the limiting protrusion 1311 is provided with a limiting slot 121. The limiting protrusion 1311 is clamped in the limiting slot 121 and can slide in the limiting slot 121, so as to restrain the inner connecting rod 12 from rotating relative to the outer connecting rod 11.

The implementation modes of the present disclosure are described in detail above in conjunction with the accompanying drawings, but the present disclosure is not limited to the described implementation modes. For those skilled in the art, various changes, modifications, alterations, and transformations are made to these implementation modes without departing from the principle and spirit of the present disclosure, and shall still fall within the protection scope of the present disclosure.

What is claimed is:

1. A retractable pickup device, comprising a control handle subassembly, a driving subassembly that is in driving connection with the control handle subassembly, and a chuck subassembly that is in driving connection with the driving subassembly,
wherein the control handle subassembly drives the chuck subassembly to be closed and opened through the driving subassembly, so as to achieve picking and placement of an object.

2. The retractable pickup device according to claim 1, wherein the chuck subassembly comprises a clamping jaw body, and clamping jaw heads which are symmetrically arranged on two sides of the clamping jaw body and are in pivot-hinge to the clamping jaw body;
the driving subassembly is arranged in the clamping jaw body; a linkage part is arranged at a tail of each clamping jaw head; the linkage part extends into the driving subassembly;
the driving subassembly drives the clamping jaw heads to be closed through the linkage parts after sliding to a position away from the clamping jaw heads;
the driving subassembly drives the clamping jaw heads to be opened through the linkage parts after sliding towards the clamping jaw heads.

3. The retractable pickup device according to claim 2, wherein an antiskid pad is arranged on the inner side of each clamping jaw head, and an antiskid protrusion is arranged on the antiskid pad; and the antiskid pads are used for increasing a friction force when the clamping jaw heads clamp an object.

4. The retractable pickup device according to claim 2, wherein the driving subassembly comprises a driving member body, a driving connecting rod mounted on the driving member body, and an elastic reset member sleeved on the driving connecting rod;
the linkage parts extend into the driving member body; one end of the elastic reset member resists against the driving member body, and the other end of the elastic reset member resists against the clamping jaw body;
after the driving connecting rod is driven to drive the driving member body to slide towards the position away from the clamping jaw heads, the elastic reset member is compressed and generates elastic restoring force;
after the driving force disappears, the elastic restoring force of the elastic reset member pushes the driving member body and the diving connecting rod towards the clamping jaw heads.

5. The retractable pickup device according to claim 4, wherein a driving member sliding chute is provided at a position, corresponding to the driving member body, on the inner side of the clamping jaw body, and the driving member sliding chute is used for allowing the driving member body to slide.

6. The retractable pickup device according to claim 4, wherein the control handle subassembly comprises a handle, a trigger mounted on the handle, and a clockwork spring box which is in driving connection with the trigger;
a pull rope is arranged between the clockwork spring box and the driving connecting rod; the trigger is pulled to drive the clockwork spring box to withdraw the pull rope into the clockwork spring box, so that the pull rope pulls the driving connecting rod to move towards a direction away from the clamping jaw heads;
the trigger is released, so that the clockwork spring box drives the trigger to be reset, and the elastic reset member drives the driving connecting rod to be reset; and the driving connecting rod pulls out the pull rope from the clockwork spring box.

7. The retractable pickup device according to claim 6, wherein an axis of the clockwork spring box is provided with an engagement gear; a position of the trigger corresponding to the engagement gear is provided with an engagement part; the engagement part may be engaged with the engagement gear;
the trigger is pulled, so that the engagement part is engaged with and drives the engagement gear to drive the clockwork spring box to be rolled back;
the trigger is released, so that the engagement gear of the clockwork spring box is engaged with and drives the engagement part of the trigger to reset the trigger.

8. The retractable pickup device according to claim 6, wherein the retractable pickup device further comprises: a telescopic rod subassembly;
one end of the telescopic rod subassembly is provided with the control handle subassembly, and the other end of the telescopic rod subassembly is provided with the chuck subassembly; the pull rope passes through the telescopic rod subassembly; and the telescopic rod subassembly is used for adjusting a distance between the control handle subassembly and the chuck subassembly.

9. The retractable pickup device according to claim 8, wherein the telescopic rod subassembly includes: an outer connecting rod, an inner connecting rod plugged to the outer connecting rod to do extend-retract motion, and a locking member capable of restraining the inner connecting rod from doing the extend-retract motion relative to the outer connecting rod;
the locking member comprises an elastic self-locking member mounted on the outer connecting rod and a nut sleeved on the inner connecting member; the inner connecting rod passes through the elastic self-locking member and extends into the outer connecting rod;
the nut is tightened on the elastic self-locking member to enable the elastic self-locking member to resist against the inner connecting rod, so that the inner connecting rod is locked relative to the outer connecting rod;
the nut is loosened from the elastic self-locking member to enable the elastic self-locking member to be released from the inner connecting member, so that the inner connecting rod is unlocked relative to the outer connecting rod.

10. The retractable pickup device according to claim 9, wherein the elastic self-locking member is provided with a limiting protrusion; a position of the inner connecting rod corresponding to the limiting protrusion is provided with a limiting slot; and the limiting protrusion is clamped in the limiting slot and can slide in the limiting slot, so as to restrain the inner connecting rod from rotating relative to the outer connecting rod.
